(19) United States
(12) Patent Application Publication
(10) Pub. No.: US 2022/0092582 A1
(43) Pub. Date: Mar. 24, 2022

(54) SYSTEMS AND METHODS FOR RENDERING CARD ART REPRESENTATION

(71) Applicant: Capital One Services, LLC, McLean, VA (US)

(72) Inventors: Jeffrey RULE, Chevy Chase, MD (US); Abdelkader BENKREIRA, Washington, DC (US)

(21) Appl. No.: 17/025,591

(22) Filed: Sep. 18, 2020

(51) Int. Cl. G06Q 20/34; G06Q 20/40

(52) U.S. Cl. CPC G06Q 20/355; G06Q 20/4018; G06Q 20/341; G06Q 20/352

(57) ABSTRACT

A digital representation system may include a transmitting device comprising a processor and a memory; an application comprising instructions for execution on a device; and a server. The transmitting device may be configured to transmit, to the application, a first set of data via one or more processes. The application may be receive, from the transmit device, the first set of data. The application may transmit, to the server, a second set of data from the application, the second set of data comprising a subset of the first set of data. The server may identify a third set of data based on the second set of data. The server may be configured transmit, to the application, the third set of data. The application may be configured display a fourth set of data, the fourth set of data comprising a digital representation of the transmitting device.

### FIELD OF THE DISCLOSURE

The present disclosure relates to systems and methods for rendering card art representations.

### BACKGROUND

The brand of a card often dictates its appearance. There is a proliferation of designs for payment cards, such as a credit card or debit card. This helps to distinguish that card from other cards. However, when viewing the card amongst other cards, personalization of the card may not be reflected in the rendering of the card in a digital wallet or application.

These and other deficiencies exist. Accordingly, there is a need to provide users with an appropriate solution that overcomes these deficiencies which provides a secure and accurate depiction of a card rendering in a digital wallet or application and enhanced user interaction experience by customizing a specific request for card appearance.

### SUMMARY OF THE DISCLOSURE

Embodiments of the present disclosure provide a digital representation system comprising: an application comprising instructions for execution on a client device; and a server, wherein: the application is configured to receive, via one or more processes, a first set of data from a transmitting device; the application is configured to transmit, to the server, a second set of data, the second set of data comprising a subset of the first set of data; the server is configured to identify a third set of data based on the second set of data; the server is configured transmit, to the application, the third set of data; and the application is configured display a fourth set of data, the fourth set of data comprising a digital representation of the transmitting device.

Embodiments of the present disclosure provide a method of rendering a digital representation, comprising: receiving, by an application comprising instructions for execution on a client device, data from a contactless card after entry of the contactless card into a communication field; transmitting, by the application, a plurality of parameters associated with the data to a server; receiving, by the application, a design associated with the contactless card based on one or more parameters from the server; and displaying, by the application, a digital representation of the design of the contactless card.

Embodiments of the present disclosure provide a computer readable non-transitory medium comprising computer-executable instructions that are executed on a processor and comprising the steps of: receiving data from a contactless card after entry of the contactless card into a communication field; transmitting a selection based on one or more options, the one or more options comprising at least one selected from the group of a size rendering and a resolution rendering, wherein the size rendering is based on screen size; transmitting, based on the selection, a plurality of parameters associated with the data, the plurality of parameters comprising at least one selected from the group of a unique card identifier, a payment account number (PAN), a card verification value (CVV), a signature panel, a network operator, and cardholder information; receiving, based on the plurality of parameters, a design associated with the contactless card; and displaying the design of the contactless card, the design comprising at least one selected from the group of a front portion of the contactless card and a rear portion of the contactless card, the design being in accordance with the selection.

### BRIEF DESCRIPTION OF THE DRAWINGS

Various embodiments of the present disclosure, together with further objects and advantages, may best be understood by reference to the following description taken in conjunction with the accompanying drawings, in the several figures of which like reference numerals identify like elements, and in which:

FIG. 1 depicts a digital representation system according to an exemplary embodiment

FIG. 2A is an illustration of a contactless card according to an exemplary embodiment.

FIG. 2B is an illustration of a contact pad of the contactless card according to an exemplary embodiment.

FIG. 3 depicts an illustration of a display of a digital representation according to an exemplary embodiment.

FIG. 4 depicts a method of rendering a digital representation according to an exemplary embodiment.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

As disclosed herein, the systems and methods are directed to partially or sufficiently reflecting the personalization of the card in the rendering of the card in a digital wallet or application. The disclosed implementations result in an image or rendering of the card displayed via an interface. As a consequence, an interface is configured to display a retrieved digital rendering of card with personalization, and enabling digital wallets and/or applications to retrieve the digital rendering for a specific user in a secure manner. Rather than retrieving a generic display of the card, personalization, including but not limited to card art appearing on the front and/or back views of the card, are captured.

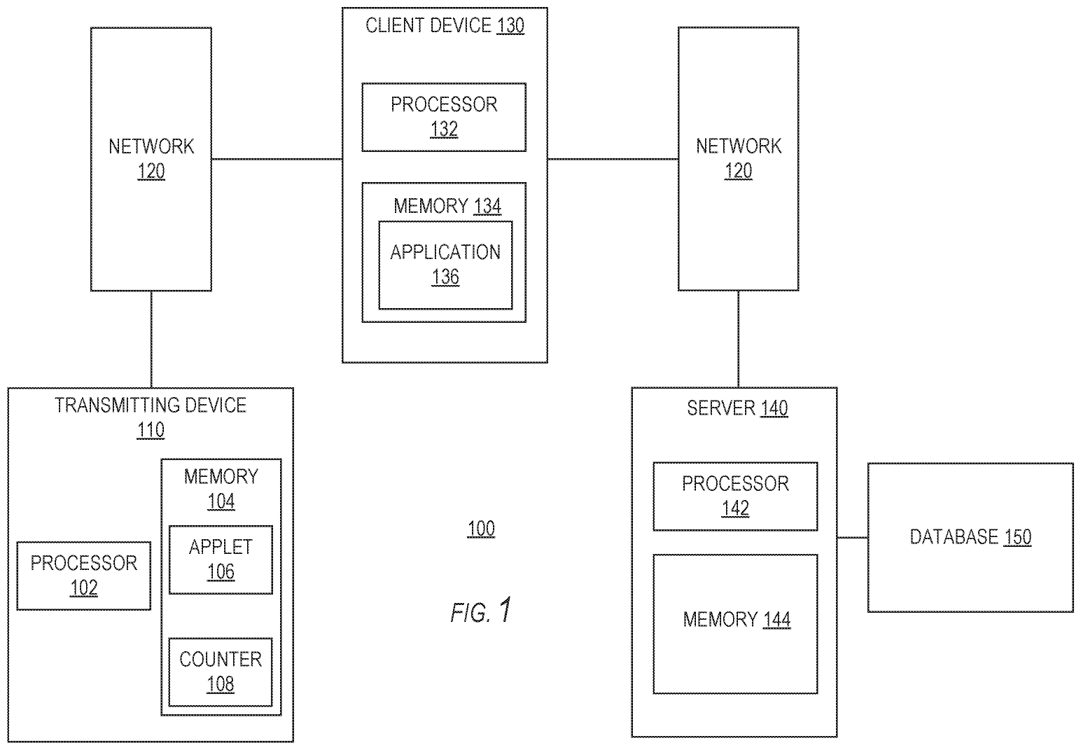

FIG. 1 illustrates a digital representation system 100 according to an exemplary embodiment. As further discussed below, system 100 may include a transmitting device 110; a network 120; a client device 130; a server 140; and a database 150. Although FIG. 1 illustrates single instances of components of system 100, system 100 may include any number of components.

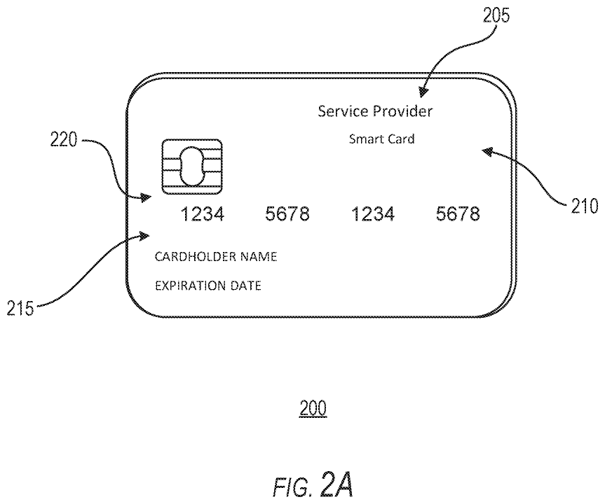

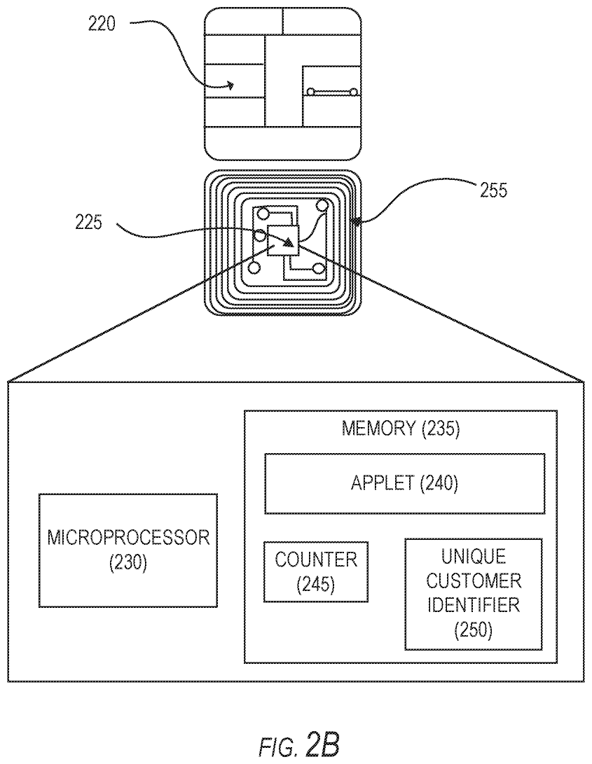

System 100 may include a transmitting device 110. As further explained below in FIGS. 2A-2B, transmitting device 110 may include one or more processors 102, and memory 104. Memory 104 may include one or more applets 106 and one or more counters 108. Transmitting device 110 may be in data communication with client device 130. For example, transmitting device may transmit data via network 120 to client device 130. In some examples, transmitting device 110 may be configured to transmit data via network 120 to client device 130 after entry into one or more communication fields of client device 130.

System 100 may include a network 120. In some examples, network 120 may be one or more of a wireless network, a wired network or any combination of wireless network and wired network, and may be configured to connect to any one of components of system 100. For example, client device 130 may be configured to connect to server 140 via network 120. In some examples, network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 120 may include, without limitation, telephone lines, fiber optics, IEEE Ethernet 902.3, a wide area network, a wireless personal area network, a LAN, or a global network such as the Internet. In addition, network 120 may support an Internet network, a wireless communication network, a cellular network, or the like, or any combination thereof. Network 120 may further include one network, or any number of the exemplary types of networks mentioned above, operating as a stand-alone network or in cooperation with each other. Network 120 may utilize one or more protocols of one or more network elements to which they are communicatively coupled. Network 120 may translate to or from other protocols to one or more protocols of network devices. Although network 120 is depicted as a single network, it should be appreciated that according to one or more examples, network 120 may comprise a plurality of interconnected networks, such as, for example, the Internet, a service provider's network, a cable television network, corporate networks, such as credit card association networks, and home networks.

System 100 may include client device 130. For example, client application 136 may comprise instructions for execution on a client device 130. The client device 130 may include one or more processors 132 coupled to memory 134. For example, client device 130 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Client device 130 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 130 may include a processor 132 and a memory 134, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 130 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some examples, client device 130 may execute one or more applications, such as software applications 136, that enable, for example, network communications with one or more components of system 100 and transmit and/or receive data.

Client device 130 may be in communication with one or more servers 140 via one or more networks 120, and may operate as a respective front-end to back-end pair with server 140. Client device 130 may transmit, for example from a mobile device application 136 executing on client device 130, one or more requests to server 140. The one or more requests may be associated with retrieving data from server 140. Server 140 may receive the one or more requests from client device 130. Based on the one or more requests from client device 130, server 140 may be configured to retrieve the requested data from one or more databases 150. Based on receipt of the requested data from the one or more databases 150, server 140 may be configured to transmit the received data to client device 130, the received data being responsive to one or more requests.

System 100 may include one or more servers 140. In some examples, server 140 may include one or more processors 142, which are coupled to memory 144. Server 140 may be configured as a central system, server or platform to control and call various data at different times to execute a plurality of workflow actions. Server 140 may be configured to connect to one or client device 130, and database 150. Server 140 may be in data communication with the client application 136. For example, a server 140 may be in data communication with the client application 136 via one or more networks 120.

System 100 may include a database 150. As explained above database 150 may be called to retrieve any type of data. The data may be requested by server 140 or client device 130. In some examples, database 150 may be configured to communicate with one or more components of system 100.

In some examples, the card 110 may be in communication with an application 136 comprising instructions for execution on a client device 130 via network 120. The communication may comprise wireless communication. In other examples, the communication may comprise wired communication. For example, the card 110 may enter a communication field with the client device 130. In some examples, the card 110 may be scanned via near field communication (NFC). The application 136 may be configured to transmit one or more parameters via one or more NFC reads to a server 140. Without limitation, the one or more parameters may include at least one selected from the group of a unique identifier of the card, payment account number (PAN), card verification value (CVV), network operator, cardholder name, expiration date, lot number, and signature.

For example, there may be different techniques to transmit the one or more parameters. In one example, a Europay, MasterCard, and Visa (EMV) transaction may be utilized as part of a contactless transaction with the card 110 in communication with an applet, such as payment applet, of the client device 130. Information on the EMV standard-based card may be read by the client device 130 when the card 110 enters the communication field of the client device 130.

In another example, the card 110 may include a tag, such as an NFC Data Exchange Format (NDEF) tag which may be read via NFC when the card 110 enters the communication field of the client device 130 and a NDEF message is requested. By way of example, a cryptogram may be generated by the card according to the systems and methods described in U.S. application Ser. No. 16/205,119.

In other examples, an imaging device, such as a camera, of the client device 130 may be configured to obtain one or more images of one or more sides of the card 110. For example, the camera may be configured to capture a front view image of the card 110. The camera may also be configured to capture a rear view image of the card 110. The application 136 may be configured to transmit one or more parameters from the captured one or more images to a server 140 via one or more networks 120. Without limitation, the one or more parameters may include at least one selected from the group of a unique identifier of the card, PAN, CVV, network operator, cardholder name, expiration date, lot number, and signature.

The server 140 may be configured to receive the one or more parameters from the application 136. In some examples, the server 140 may be configured to retrieve card art. For example, the server 140 may be configured to obtain card art stored in one or more databases 150. The server 140 may be configured to look up the card art in the database 150 to determine a match based on the one or more parameters. In another example, the server 140 may include the card art. The server 140 may be configured to transmit the card art design to the application 136 based on an outcome associated with the match.

In other examples, the application 136 may be configured to display a hyperlink that communicates with the server 140. For example, the hyperlink may comprise a link configured to retrieve the card art from the server 140.

The application 136 may be configured to receive the card art design from the server 140. In some examples, the application 136 may be configured to display one or more images associated with the card art design. The digital card representation of the card art design may include a variety of format types. Without limitation, the format type may include at least one selected from the group of a static image file (such as JPEG, PNG, SVG), a static document file (such as PDF, PSD), an animated file (such as GIF, SWF), and web code (such as HTML, CSS, JavaScript).

The application 136 may be configured to output the digital card representation based on one or more requests. The one or more requests may be associated with screen size and/or desired resolution quality. In some examples, the application may be configured to display the digital card representation in different sizes. For example, the application 136 may be configured display the digital card representation in one or more sizes, such as a small size or a large size, depending on screen size of the client device 130. The application 136 may also be configured to display the digital card representation in one or more resolution types, such as a low resolution or high resolution. Thus, the digital card representation may be requested and compliant with the one or more requests.

In addition, the application 136 and server 140 may be configured to generate or retrieve different portions of the digital card representation. In some examples, the application 136 may be configured to generate or retrieve a first image, and the server 140 may be configured to generate or retrieve a second image. By way of example, the first image may comprise a generated or retrieved signature image, and the second image may comprise a generated or retrieved unique identifier image. In some examples, the first image and the second image may be superimposed to produce a third image resulting in the displayed digital card representation. In some examples, server 140 may be configured to include data, such as metadata, descriptive of an order in which the first and second images are stacked on top of each other for superimposition. In this manner, application 136 may not need to transmit requests to do so. Application 136 may be configured to determine if a portion of the images are displayed. In another example, application 136 may be configured to determine if all of the images are displayed. Application 136 may be configured to selectively display one or more parameters due to one or more security reasons, including data security, privacy, and fraud prevention. Without limitation, the one or more parameters may include at least one selected from the group of a unique identifier of the card, PAN, CVV, network operator, cardholder name, expiration date, lot number, and signature. For example, application 136 may be configured to determine if a signature and/or a card number is displayed, and thus determine if any of the images are displayed. Thus, these different digital assets may be generated from the application 136 and the server 140. Similarly, the digital card representation may be displayed so as to include front and/or rear view portions of the card, which may be generated or retrieved by the application 136 and server 140.

FIG. 2A illustrates one or more transmitting devices 200. Transmitting device 200 may reference same or similar components of transmitting device 110, as explained above with respect to FIG. 1. Although FIGS. 2A and 2B illustrate single instances of components of transmitting device 200, any number of components may be utilized.

Transmitting device 200 may be configured to communicate with one or more components of system 100. Transmitting device 200 may comprise a contactless card, which may comprise a payment card, such as a credit card, debit card, or gift card, issued by a service provider 205 displayed on the front or back of the card 200. In some examples, the contactless card 200 is not related to a payment card, and may comprise, without limitation, an identification card. In some examples, the payment card may comprise a dual interface contactless payment card. The contactless card 200 may comprise a substrate 210, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 200 may have physical characteristics compliant with the ID-1 format of the ISO/IEC 7810 standard, and the contactless card may otherwise be compliant with the ISO/IEC 14443 standard. However, it is understood that the contactless card 200 according to the present disclosure may have different characteristics, and the present disclosure does not require a contactless card to be implemented in a payment card.

The contactless card 200 may also include identification information 215 displayed on the front and/or back of the card, and a contact pad 220. The contact pad 220 may be configured to establish contact with another communication device, including but not limited to a user device, smart phone, laptop, desktop, or tablet computer. The contactless card 200 may also include processing circuitry, antenna and other components not shown in FIG. 2A. These components may be located behind the contact pad 220 or elsewhere on the substrate 210. The contactless card 200 may also include a magnetic strip or tape, which may be located on the back of the card (not shown in FIG. 2A).

As illustrated in FIG. 2B, the contact pad 220 of FIG. 2A may include processing circuitry 225 for storing and processing information, including a microprocessor 230 and a memory 235. It is understood that the processing circuitry 225 may contain additional components, including processors, memories, error and parity/CRC checkers, data encoders, anticollision algorithms, controllers, command decoders, security primitives and tamperproofing hardware, as necessary to perform the functions described herein.

The memory 235 may be a read-only memory, write-once read-multiple memory or read/write memory, e.g., RAM, ROM, and EEPROM, and the contactless card 200 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 235 may be configured to store one or more applets 240, one or more counters 245, and a customer identifier 250. The one or more applets 240 may comprise one or more software applications configured to execute on one or more contactless cards, such as Java Card applet. However, it is understood that applets 240 are not limited to Java Card applets, and instead may be any software application operable on contactless cards or other devices having limited memory. The one or more counters 245 may comprise a numeric counter sufficient to store an integer. The customer identifier 250 may comprise a unique alphanumeric identifier assigned to a user of the contactless card 200, and the identifier may distinguish the user of the contactless card from other contactless card users. In some examples, the customer identifier 250 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 220 or entirely separate from it, or as further elements in addition to processor 230 and memory 235 elements located within the contact pad 220.

In some examples, the contactless card 200 may comprise one or more antennas 255. The one or more antennas 255 may be placed within the contactless card 200 and around the processing circuitry 225 of the contact pad 220. For example, the one or more antennas 255 may be integral with the processing circuitry 225 and the one or more antennas 255 may be used with an external booster coil. As another example, the one or more antennas 255 may be external to the contact pad 220 and the processing circuitry 225.

In an embodiment, the coil of contactless card 200 may act as the secondary of an air core transformer. The terminal may communicate with the contactless card 200 by cutting power or amplitude modulation. The contactless card 200 may infer the data transmitted from the terminal using the gaps in the contactless card's power connection, which may be functionally maintained through one or more capacitors. The contactless card 200 may communicate back by switching a load on the contactless card's coil or load modulation. Load modulation may be detected in the terminal's coil through interference.

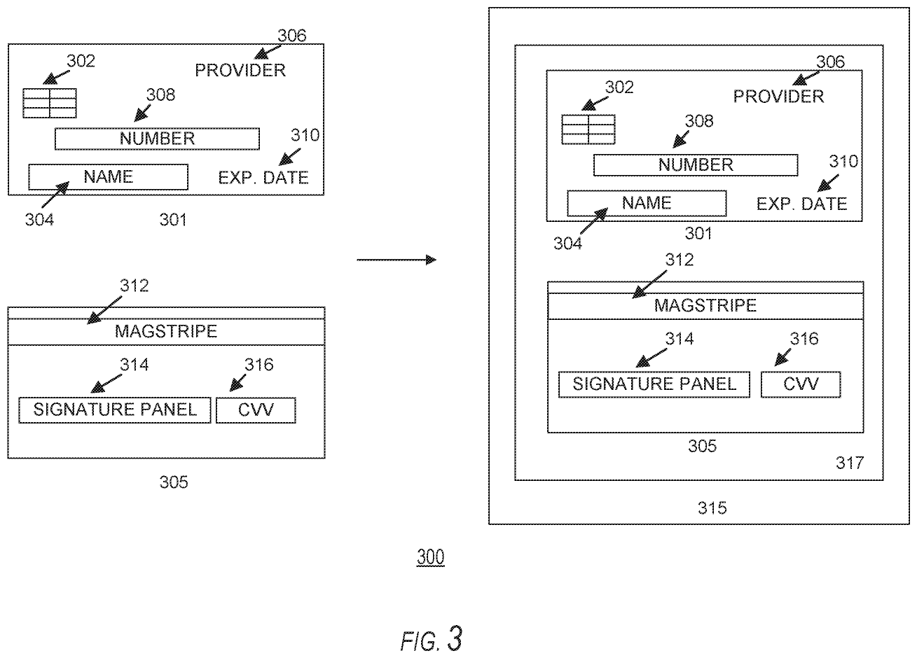

FIG. 3 depicts an illustration 300 of an interface display of a digital representation according to an exemplary embodiment. FIG. 3 may reference same or similar components as explained above with respect to FIG. 1 and FIGS. 2A-2B. Although FIG. 3 illustrates single instances of components of transmitting device 301, 305, and client device 315, any number of components may be utilized.

In some examples, transmitting device 301 may reference transmitting device 110 of FIG. 1. In some examples, transmitting device 301 may reference transmitting device 200 of FIG. 2A and FIG. 2B. Transmitting device 301 may depict an exemplary front view of transmitting device 301. Transmitting device 305 may depict an exemplary rear view of transmitting device 301.

By way of example, transmitting device 301 may include processor 302, name 304, provider 306, number 308, and expiration date 310. It is understood that only portions of this information and/or additional information may be included in the front view and is therefore not limited to such. In addition, the front view may include a display of any of this information in any sequence or arrangement. In addition, front view may include any additional graphics and/or text (not shown). Processor 302 may be similar to processing circuitry 225. Name 304 may be similar to identification information 215. Provider 305 may be similar to service provider 205. Any of the information of front view of transmitting device 301 may include a logo and/or text associated therewith.

Transmitting device 305 may depict an exemplary rear view of transmitting device 301. By way of example, transmitting device 305 may include magstripe 312, signature panel 314, and card verification value 316. It is understood that only portions of this information and/or additional information may be included in the rear view and is therefore not limited to such. Any of the information of rear view of transmitting 305 may include a logo and/or text associated therewith.

Client device 315 may be same or similar to client device 130, as explained above with respect to FIG. 1. Client device 315 may be in data communication with transmitting device 301 and 305 via one or more networks (not shown), similar to network 120 as explained above with respect to FIG. 1. Client device 315 may retrieve data from one or more servers (not shown), similar to server 140 as explained above with respect to FIG. 1. As previously explained above with respect to FIG. 1, application of client device 315 may be configured to display front and/or rear views of transmitting device 301 and 305 via interface 317. In addition, as previously explained above with respect to FIG. 1, one or more portions of the information of respective front and/or rear views of transmitting device 301 and 305 may be generated or retrieved from application of client device 315 and one or more portions of the information of respective front and/or rear views of transmitting device 301 and 305 may be generated or retrieved from the server.

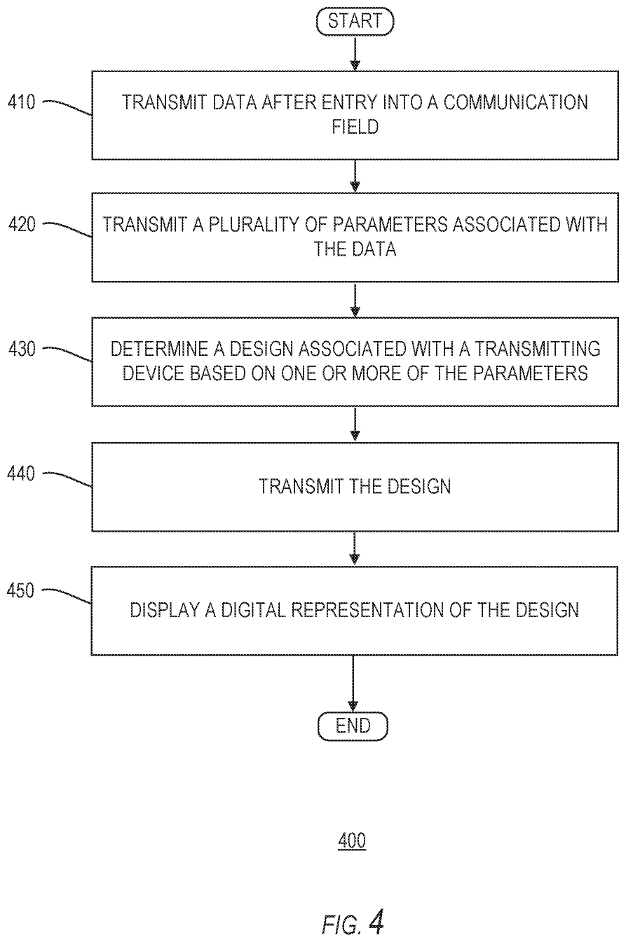

FIG. 4 depicts a method 400 of rendering a digital representation. FIG. 4 may reference same or similar components of system 100, transmitting device 200 of FIG. 2A and FIG. 2B, and display interface 300 of FIG. 3.

At block 405, the method may include transmitting data after entry into a communication field. In some examples, the transmitting device or card may be in communication with an application comprising instructions for execution on a client device. The communication may comprise wireless communication. In other examples, the communication may comprise wired communication. For example, the card may enter a communication field with the application. In some examples, the card may be scanned via near field communication. The application may be configured to transmit one or more parameters via one or more NFC reads to a server. Without limitation, the one or more parameters may include at least one selected from the group of a unique identifier of the card, a payment account number, card verification value, network operator, cardholder name, expiration date, lot number, and signature.

At block 420, the method may include transmitting a plurality of parameters associated with the data. For example, there may be different techniques to transmit the one or more parameters. In one example, a Europay, MasterCard, and Visa (EMV) transaction may be utilized as part of a contactless transaction with the card in communication with an applet, such as payment applet, of the client device. Information on the EMV standard-based card may be read by the client device when the card enters the communication field of the client device.

In another example, the card may include a tag, such as an NFC Data Exchange Format (NDEF) tag which may be read via NFC when the card enters the communication field of the client device and a NDEF message is requested. By way of example, a cryptogram may be generated by the card according to the systems and methods described in U.S. application Ser. No. 16/205,119.

In other examples, an imaging device, such as a camera, of the client device may be configured to obtain one or more images of one or more sides of the card. For example, the camera may be configured to capture a front view image of the card. The camera may also be configured to capture a rear view image of the card. The application may be configured to transmit one or more parameters from the captured one or more images to a server. Without limitation, the one or more parameters may include at least one selected from the group of a unique identifier of the card, a payment account number, card verification value, network operator, cardholder name, expiration date, lot number, and signature.

At block 430, the method may include determining a design associated with a transmitting device based on one or more of the plurality of parameters. The server may be configured to receive the one or more parameters from the application. In some examples, the server may be configured to retrieve card art. For example, the server may be configured to obtain card art stored in one or more databases. The server may be configured to look up the card art in the database to determine a match based on the one or more parameters. In another example, the server may include the card art. The server may be configured to transmit the card art design to the application based on an outcome associated with the match.

In other examples, the application may be configured to display a hyperlink that communicates with the server. For example, the hyperlink may comprise a link configured to retrieve the card art from the server.

At block 440, the method may include transmitting the design. The server may be configured to transmit the card art design to the application of the client device. The application may be configured to receive the card art design from the server.

At block 450, the method may include displaying a digital representation of the design. In some examples, the application may be configured to display one or more images associated with the card art design. The digital card representation of the card art design may include a variety of format types. Without limitation, the format type may include at least one selected from the group of a static image file (such as JPEG, PNG, SVG), a static document file (such as PDF, PSD), an animated file (such as GIF, SWF), and web code (such as HTML, CSS, JavaScript).

The application may be configured to output the digital card representation based on one or more requests. The one or more requests may be associated with screen size and/or desired resolution quality. In some examples, the application may be configured to display the digital card representation in different sizes. For example, the application may display the digital card representation in one or more sizes, such as a small size or a large size, depending on screen size of the client device. The application may also be configured to display the digital card representation in one or more resolution types, such as a low resolution or high resolution. Thus, the digital card representation may be requested and compliant with the one or more requests.

In addition, the application and server may be configured to generate or retrieve different portions of the digital card representation. In some examples, the application may be configured to generate or retrieve a first image, and the server may be configured to generate or retrieve a second image. By way of example, the first image may comprise a generated or retrieved signature image, and the second image may comprise a generated or retrieved unique identifier image. In some examples, the first image and the second image may be superimposed to produce a third image resulting in the displayed digital card representation. In some examples, the server may be configured to include data, such as metadata, descriptive of an order in which the first and second images are stacked on top of each other for superimposition. In this manner, the application may not need to transmit requests to do so. The application may be configured to determine if a portion of the images are displayed. In another example, the application may be configured to determine if all of the images are displayed. The application may be configured to selectively display one or more parameters due to one or more security reasons, including data security, privacy, and fraud prevention. Without limitation, the one or more parameters may include at least one selected from the group of a unique identifier of the card, PAN, CVV, network operator, cardholder name, expiration date, lot number, and signature. For example, the application may be configured to determine if a signature and/or a card number is displayed, and thus determine if any of the images are displayed. Thus, these different digital assets may be generated from the application and the server. Similarly, the digital card representation may be displayed so as to include front and/or rear view portions of the card, which may be generated or retrieved by the application and server.

It is understood that the present disclosure is not limited to a particular card or type of card. The present disclosure includes, without limitation, payment cards (e.g., credit cards, debit cards, gift cards), identification cards (e.g., driver's licenses, passports), membership cards, account cards, and loyalty cards.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A digital representation system comprising:
a transmission device comprising a processes and memory, the memory comprising a first set of data associated with a personalized digital representation of the transmitting device, wherein the first set of data is stored as one or more first NDEF messages/records transmittable via NFC to a corresponding application stored on a client device; and
a server communicatively coupled to the corresponding application, and,
configured to construct the personalized digital representation of the transmitting device from the first set of data transmitted by the transmitting device to the corresponding application on the client device and communicated, via the corresponding application, to the server; and
the corresponding application being configured to provide the personalized digital representation of the transmitting device to one or more payment applications, for display as an accurate visual indicator of a payment method associated with the transmitting device.

2. The digital representation system of claim 1, wherein the first set of data is obtained, from the transmitting device, by the corresponding application using image capture.

3. The digital representation system of claim 2, wherein the NFC comprises at least one selected from the group of a Europay, Mastercard, and Visa (EMV) transaction and an NFC data exchange format (NDEF) communication.

4. The digital representation system of claim 1, wherein the first set of data comprises at least one selected from the group of a unique card identifier, a payment account number (PAN), a card verification value (CVV), a signature panel, a network operator, and cardholder information.

5. The digital representation system of claim 1, wherein one or more data parameters associated with the first set of data are used by the server to locate and retrieve a second set of data associated with the personalized digital representation of the transmitting device.

6. The digital representation system of claim 1, wherein the accurate visual indicator comprises at least one selected from the group of a static image file, a static document file, an animated file, and web code.

7. The digital representation system of claim 1, wherein the server is configured to render a first portion of the personalized digital representation, and the corresponding application is configured to render a second portion of the personalized digital representation.

8. The digital representation system of claim 1, wherein the server is configured to store one or more hyperlinks comprising the personalized digital representation of the transmitting device.

9. The digital representation system of claim 1, wherein the corresponding application is configured to display a first surface of the transmitting device, the first surface associated with the digital representation of the transmitting device.

10.-20. (canceled)

21. The digital representation system of claim 5, wherein the server is configured to construct a personalized digital representation of the transmitting device using the first set of data and the second set of data.

22. The digital representation system of claim 21, wherein the second set of data comprises a card art design associated with the transmitting device.

23. The digital representation system of claim 1, wherein the transmitting device corresponds to a contactless card.
